(19) United States
(12) Patent Application Publication
(10) Pub. No.: US 2026/0037176 A1
(43) Pub. Date: Feb. 5, 2026

(54) DATA PROCESSING METHOD AND APPARATUS, SERVER, AND STORAGE MEDIUM

(71) Applicant: Xueqing ZHANG, Suzhou, Jiangsu (CN)

(72) Inventor: Xueqing ZHANG, Suzhou, Jiangsu (CN)

(21) Appl. No.: 19/139,456

(22) PCT Filed: May 28, 2024
(86) PCT No.: PCT/CN2024/095802

§ 371 Date: Jun. 16, 2025

(30) Foreign Application Priority Data
Dec. 12, 2023 (CN) 202311697134.9

(51) Int. Cl. G06F 3/06

(52) U.S. Cl. CPC G06F 3/0655; G06F 3/0604; G06F 3/0673

(57) ABSTRACT

The present application relates to a data processing method and apparatus, a server, and a storage medium. The data processing method is applied to a storage server, the storage server includes a network interface card and a solid-state drive, and the solid-state drive includes a controller memory buffer. The method includes: receiving, by the network interface card, a data operation command which is sent by a host, the data operation command carrying input/output data; sending the input/output data to the solid-state drive according to the data operation command by the network interface card; and operating on the controller memory buffer according to the input/output data by the solid-state drive. By adopting this method, data transmission may bypass the CPU of the storage server, thus reducing the consumption of CPU resources.

### CROSS-REFERENCE TO RELATED APPLICATION

This application claims priority to Chinese Patent Application No. 202311697134.9, filed on Dec. 12, 2023 in China National Intellectual Property Administration and entitled “Data Processing Method and Apparatus, Server, and Storage Medium”, which is hereby incorporated by reference in its entirety.

### FIELD

The present application relates to the field of computer technology, and in particular to a data processing method and apparatus, a server, and a storage medium.

### BACKGROUND

Driven by current market demands, the global storage data volume is surging at a zettabyte (ZB) scale, the performance of individual storage drives, the internal CPU-to-memory access bandwidth within a storage system and the network interface bandwidth used for storage have been significantly improved, and customers also demand higher input/output (I/O) performance (higher bandwidth, IOPS, and lower latency) from storage systems. However, in the post-Moore era, the development of semiconductor fabrication process has slowed down and single-core computing power has stagnated (52%->3.5%), which poses significant performance improvement challenges for storage system design.

Ethernet Bunch of Flash (EBOF) is a new type of high-density and high- performance storage server that uses Ethernet as the underlying network transmission technology. It primarily accesses and manages NVMe Flash SSDs through NVMe over Fabric (NOF) connections, achieving efficient resource pooling and sharing with near-local media access performance. The computing and storage resources can be independently scaled.

In a data path of a current EBOF storage server, input/output data must flow into and out of the L3 cache of the CPU and double data rate (DDR) memory modules for each data movement, which increases CPU power consumption.

### SUMMARY

There is provided a data processing method that is applied to a storage server, the storage server including a network interface card and a solid-state drive, and the solid-state drive including a controller memory buffer, the method including:
receiving, by the network interface card, a data operation command which is sent by a host, the data operation command carrying input/output data;
sending the input/output data to the solid-state drive according to the data operation command by the network interface card; and
operating on the controller memory buffer according to the input/output data by the solid-state drive.

In one embodiment, the solid-state drive further includes a controller, a flash memory device, and an internal direct random access memory, the internal direct random access memory including the controller memory buffer.

In one embodiment, when the data operation command is a data read command, the input/output data includes address information. The operating on the controller memory buffer according to the input/output data by the solid-state drive includes: receiving, by the controller, the address information and sending the address information to the internal direct random access memory; determining a target address corresponding to the controller memory buffer according to the address information by the internal direct random access memory; and reading target data from the target address corresponding to the controller memory buffer by the internal direct random access memory.

In one embodiment, the method further includes: sending the target data to the controller by the internal direct random access memory; sending the target data to the network interface card as a read completion message by the controller; and returning the read completion message to the host by the network interface card.

In one embodiment, the controller memory buffer includes at least one buffer unit. The reading target data from the target address corresponding to the controller memory buffer by the internal direct random access memory includes: determining a first target buffer unit from the at least one buffer unit according to the target address by the internal direct random access memory; and reading the target data from the first target buffer unit by the internal direct random access memory.

In one embodiment, when the data operation command is a data write command, the input/output data includes data to be written and corresponding write address information. The operating on the controller memory buffer according to the input/output data by the solid-state drive includes: receiving, by the controller, the data to be written and the corresponding write address information and sending the data to be written and the corresponding write address information to the internal direct random access memory; determining an address to be written corresponding to the controller memory buffer according to the write address information by the internal direct random access memory; and writing the data to be written to the address to be written corresponding to the controller memory buffer by the internal direct random access memory.

In one embodiment, the method further includes: obtaining, by the internal direct random access memory, written data from the controller memory buffer and sending the written data to the flash memory device; storing, by the flash memory device, the written data, generating a write completion message and sending the write completion message to the controller; sending the write completion message to the network interface card by the controller; and returning the write completion message to the host by the network interface card.

In one embodiment, the controller memory buffer includes at least one buffer unit. The writing the data to be written to the address to be written corresponding to the controller memory buffer by the internal direct random access memory includes: determining a second target buffer unit from the at least one buffer unit according to the address to be written by the internal direct random access memory; and writing the data to be written into the second target buffer unit by the internal direct random access memory.

In one embodiment, the controller includes a first register and a second register, the first register and the second register being respectively configured to describe different attribute information of the controller memory buffer.

In one embodiment, the first register defines a location of the controller memory buffer, and first attribute information corresponding to the first register is set to indicate that the controller supports the controller memory buffer.

In one embodiment, the second register defines a size of the controller memory buffer, and second attribute information corresponding to the second register is set to indicate that the controller supports the controller memory buffer.

In one embodiment, the sending the input/output data to the solid-state drive according to the data operation command by the network interface card includes: sending the input/output data to a Peripheral Component Interconnect Express (PCIe) switching unit according to the data operation command by the network interface card; and sending the input/output data to the solid-state drive by the PCIe switching unit.

There is provided a data processing apparatus that is applied to a storage server, the storage server including a network interface card and a solid-state drive, and the solid-state drive including a controller memory buffer, the apparatus including:
a receiving module configured to receive, by the network interface card, a data operation command which is sent by a host, the data operation command carrying input/output data;
a sending module configured to send the input/output data to the solid-state drive according to the data operation command by the network interface card; and an operation module configured to operate on the controller memory buffer according to the input/output data by the solid-state drive.

There is provided a server that includes a memory, a processor, and computer-readable instructions stored on the memory and executable by the processor. The computer-readable instructions, when executed by the processor, implement the following steps:
receiving, by a network interface card, a data operation command which is sent by a host, the data operation command carrying input/output data; sending the input/output data to a solid-state drive according to the data operation command by the network interface card; and
operating on a controller memory buffer according to the input/output data by the solid-state drive.

There are provided one or more non-volatile computer-readable storage media that have computer-readable instructions stored therein. The computer-readable instructions, when executed by one or more processors, cause the one or more processors to implement the following steps:
receiving, by a network interface card, a data operation command which is sent by a host, the data operation command carrying input/output data;
sending the input/output data to a solid-state drive according to the data operation command by the network interface card; and
operating on a controller memory buffer according to the input/output data by the solid-state drive.

### BRIEF DESCRIPTION OF THE DRAWINGS

FIG. 1 is a schematic flowchart of a data processing method in one or more embodiments;

FIG. 1-A is a data flow diagram of a data processing method in the prior art;

FIG. 1-B is a data flow diagram of a data processing method in one or more embodiments;

FIG. 2 is a schematic flowchart illustrating steps of operating on a controller memory buffer in one or more embodiments;

FIG. 2-A is a schematic diagram illustrating an internal structure of a solid-state drive in one or more embodiments;

FIG. 3 is a schematic flowchart illustrating steps of operating on a controller memory buffer in one or more embodiments;

FIG. 4 is a schematic flowchart illustrating steps of reading target data in one or more embodiments;

FIG. 5 is a schematic flowchart illustrating steps of operating on a controller memory buffer in one or more embodiments;

FIG. 6 is a schematic flowchart illustrating steps of operating on a controller memory buffer in one or more embodiments;

FIG. 7 is a schematic flowchart illustrating steps of writing data to a controller memory buffer in one or more embodiments;

FIG. 8 is a schematic flowchart illustrating steps of sending a data operation command in one or more embodiments;

FIG. 9 is a block diagram illustrating a structure of a data processing apparatus in one or more embodiments; and

FIG. 10 is diagram illustrating an internal structure a computer device in one or more embodiments.

### DETAILED DESCRIPTION

To make the objectives, technical solutions, and advantages of the present application clearer, the embodiments of the present application will be further described in detail below with respect to accompanying drawings and embodiments. It should be understood that the specific embodiments described herein are only used to explain the present application and are not intended to limit the present application.

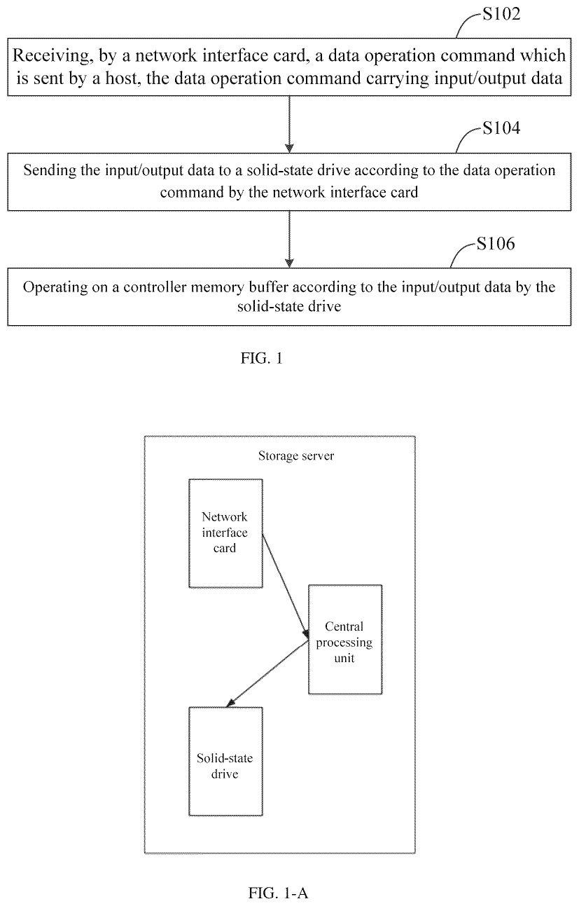

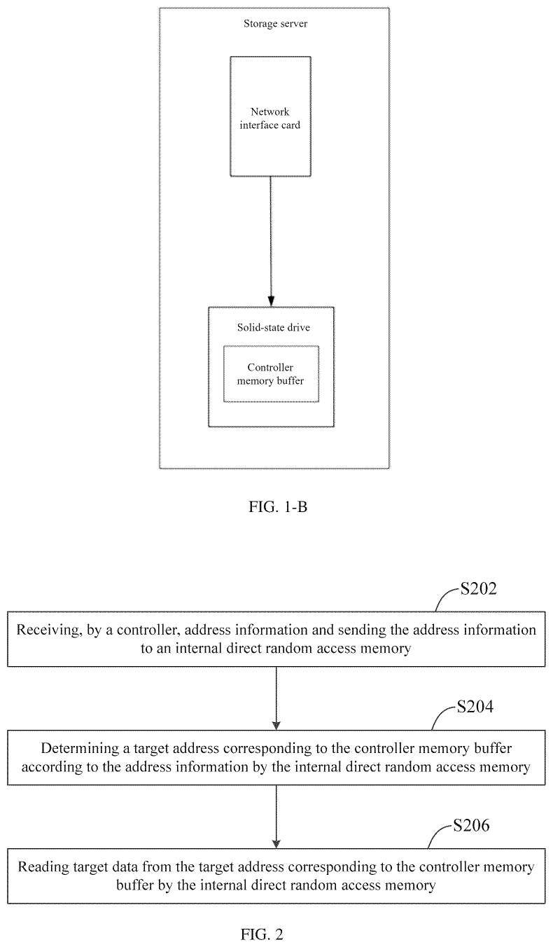

In one embodiment, as shown in FIG. 1, a data processing method is provided. Taking the application of this method in a storage server as an example for illustration, the storage server includes a network interface card and a solid-state drive. The solid-state drive includes a controller memory buffer. The method includes the following steps.

Step 102, receiving, by the network interface card, a data operation command which is sent by a host, the data operation command carrying input/output data.

The storage server may be an EBOF server. Ethernet Bunch of Flash (EBOF) is a new type of high-density and high-performance storage server that uses Ethernet as the underlying network transmission technology. It primarily accesses and manages NVMe (Non-Volatile Memory Express) Flash SSDs (Solid-State Drives) through NVMe over Fabrics (NOF) connections. The storage server includes, but not limited to, a network interface card and a solid-state drive. The network interface card is computer hardware designed to allow the storage server to communicate over a computer network. The solid-state drive (or solid-state disk, abbreviated as SSD) is a hard disk made of an array of solid-state electronic storage chips. The solid-state drive includes a controller memory buffer (CMB). The controller memory buffer CMB is a read/write storage buffer inside the solid-state drive, which maps the internal DDR (Double Data Rate) storage space of the SSD to the physical address space of a host through PCIe base address registers (BARs) spatially.

The host refers to a computer that communicates with the storage server. The host is also provided with a network interface card for communication with the network interface card on the storage server. Specifically, the host sends a data operation command through its network interface card to the storage server, and the storage server receives, through its network interface card, the data operation command sent by the host. The data operation command carries input/output data. The data operation command may be a data read command or a data write command, and different data operation commands carry different input/output data.

Step 104, sending the input/output data to the solid-state drive according to the data operation command by the network interface card.

Specifically, the network interface card sends the carried input/output data to the solid-state drive according to the data operation command. In the prior art, the network interface card needs to forward data through a central processing unit CPU. In the present application, after receiving a data operation command sent by another host, the network interface card directly sends the carried input/output data to the solid-state drive according to the data operation command in such a way that the central processing unit CPU is completely bypassed and no CPU processing is required. Therefore, the consumption of CPU resources can be significantly reduced.

Step 106, operating on the controller memory buffer according to the input/output data by the solid-state drive.

Specifically, after receiving the input/output data sent by the network interface card, the solid-state drive analyzes the input/output data, obtains an analysis result, and operates on the controller memory buffer according to the analysis result. For example, if the input/output data is data carried by a data read command, the solid-state drive reads data from the controller memory buffer according to the input/output data. As another example, if the input/output data is data carried by a data write command, the solid-state drive writes data into the controller memory buffer according to the input/output data. That is, the storage server enables direct data communication with the solid-state drive through the network interface card, eliminating the need for the central processing unit CPU to perform data transmission operations or memory copy operations, thereby significantly reducing the consumption of CPU resources.

For example, as shown in FIG. 1-A, which illustrates a data flow diagram of a data processing method in the prior art, the storage server in FIG. 1-A includes a network interface card, a central processing unit CPU, and a solid-state drive SSD. The network interface card receives a data operation command sent by another host, data carried by the data operation command is sent to the central processing unit CPU by the network interface card, and the central processing unit CPU sends the data to the solid-state drive SSD. That is, in the data processing method of the prior art, each data movement must be enabled through the central processing unit CPU, thereby increasing power consumption.

However, as shown in FIG. 1-B, which illustrates a data flow diagram of a data processing method, the storage server in FIG. 1-B includes a network interface card and a solid-state drive SSD that includes a controller memory buffer CMB. The network interface card receives a data operation command sent by another host, data carried by the data operation command is sent directly to the solid-state drive SSD by the network interface card, and the solid-state drive SSD operates on its internal controller memory buffer CMB according to the carried data. As a result, the central processing unit CPU is completely bypassed, eliminating the need for the CPU to perform data transmission operations or memory copy operations, thereby significantly saving the CPU resources.

In the data processing method, data is transmitted from the host through its network interface card directly to the network interface card of the storage server, which then directly transmits the data to the solid-state drive to complete the data transmission operation. During the entire data transmission process, the central processing unit CPU of the storage server is completely bypassed, eliminating the need for the CPU to perform data transmission operations or memory copy operations, thereby significantly reducing the consumption of CPU resources.

In one embodiment, the solid-state drive further includes a controller, a flash memory device, and an internal direct random access memory, the internal direct random access memory including the controller memory buffer.

In addition to the controller memory buffer CMB, the solid-state drive SSD further includes a controller, a flash memory device, and an internal direct random access memory. The internal direct random access memory includes the controller memory buffer CMB. The controller in the solid-state drive SSD is configured to control the solid-state drive. The flash memory device may be a non-volatile medium configured to store data. The internal direct random access memory is an internal memory that directly exchanges data with the controller within the solid-state drive. It can be read and written at any time (except when refreshed) with a high speed and usually serves as a temporary data storage medium.

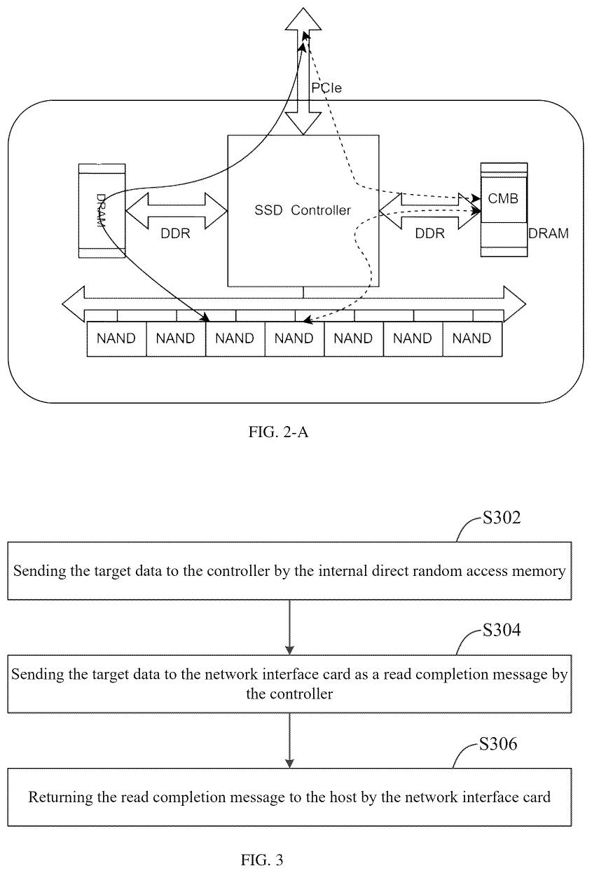

For example, as shown in FIG. 2-A, which illustrates a schematic diagram of the internal structure of a solid-state drive in one embodiment, the solid-state drive SSD includes the following modules: an SSD controller, an NAND flash memory device, and an internal direct random access memory (DRAM) that includes a CMB. During operation, the SSD controller may communicate with a host through a bus. For example, an SSD controller using the Peripheral Component Interconnect Express (PCI Express or PCIe) bus standard may further communicate with the DRAM device through a double data rate (DDR) bus and be connected with the NAND flash memory device through a physical interface.

In one embodiment, as shown in FIG. 2, when the data operation command is a data read command, the input/output data includes address information, and the operating on the controller memory buffer according to the input/output data by the solid-state drive includes the following steps.

Step 202, receiving, by the controller, the address information and sending the address information to the internal direct random access memory.

Step 204, determining a target address corresponding to the controller memory buffer according to the address information by the internal direct random access memory.

Step 206, reading target data from the target address corresponding to the controller memory buffer by the internal direct random access memory.

When the data operation command is a data read command, the input/output data carried by the data read command includes address information, and the address information is the information related to an address, at which data to be read is located, and includes an address block, internal address information, etc. Specifically, the solid-state drive receives the address information sent by the network interface card through the controller and sends the address information to the internal direct random access memory. The internal direct random access memory determines a target address corresponding to the controller memory buffer according to the address information and obtains target data from the target address. That is, the data reading is achieved by reading from the controller memory buffer in the solid-state drive.

In one embodiment, as shown in FIG. 3, the aforementioned method further includes the following steps.

Step 302, sending the target data to the controller by the internal direct random access memory.

Step 304, sending the target data to the network interface card as a read completion message by the controller.

Step 306, returning the read completion message to the host by the network interface card.

Specifically, after the target data have been successfully read from the target address corresponding to the controller memory buffer by the internal direct random access memory, the internal direct random access memory sends the target data to the controller, the controller sends the target data in the form of a read completion message to the network interface card, and after receiving the read completion message, the network interface card returns the read completion message to the host. The remote direct memory access (RDMA) technology can be used as a protocol between the host and the storage server. That is, after the target data have been successfully read from the controller memory buffer in the internal direct random access memory, the host needs to be informed with a read completion message, and as a result, the read completion message is generated by the controller and transferred to the host through the network interface card.

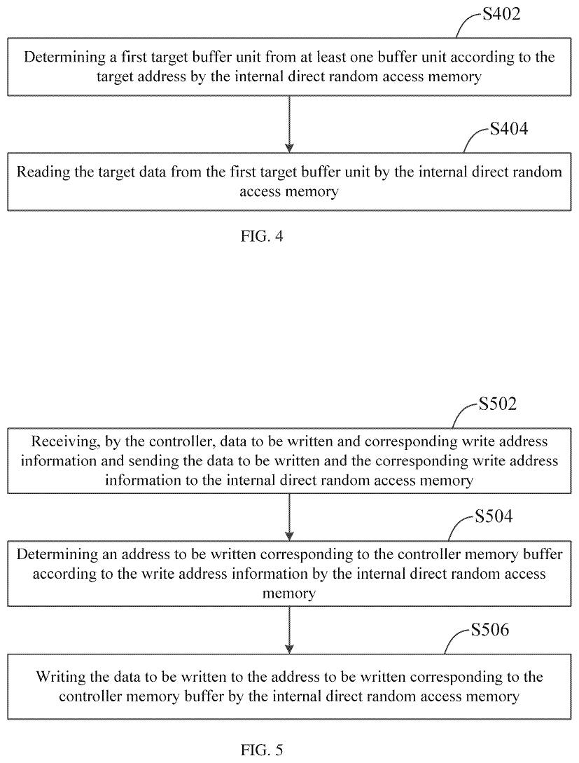

In one embodiment, as shown in FIG. 4, the controller memory buffer includes at least one buffer unit. The reading target data from the target address corresponding to the controller memory buffer by the internal direct random access memory includes the following steps.

Step 402, determining a first target buffer unit from the at least one buffer unit according to the target address by the internal direct random access memory.

Step 404, reading the target data from the first target buffer unit by the internal direct random access memory.

When the controller memory buffer CMB includes at least one buffer unit, after determining the target address, the internal direct random access memory may determine the first target buffer unit from the plurality of buffer units according to the target address and read the target data from the first target buffer unit. Each buffer unit in the controller memory buffer is associated with an address, and the corresponding first target buffer unit may be determined by the target address.

In one embodiment, as shown in FIG. 5, when the data operation command is a data write command, the input/output data includes data to be written and corresponding write address information, and the operating on the controller memory buffer according to the input/output data by the solid-state drive includes the following steps.

Step 502, receiving, by the controller, the data to be written and the corresponding write address information and sending the data to be written and the corresponding write address information to the internal direct random access memory.

Step 504, determining an address to be written corresponding to the controller memory buffer according to the write address information by the internal direct random access memory.

Step 506, writing the data to be written to the address to be written corresponding to the controller memory buffer by the internal direct random access memory.

When the data operation command is a data write command, the data write command is used to indicate a data write operation, and the input/output data carried by the data write command includes the data to be written and the corresponding write address information. The write address information is information related to the address to be written and includes an address block to be written and the like.

Specifically, after receiving the data to be written and the corresponding address information sent by the network interface card, the controller sends the data to be written and the corresponding address information to the internal direct random access memory. The internal direct random access memory determines the address to be written corresponding to the controller memory buffer according to the address information, and writes the data to be written into the address to be written corresponding to the controller memory buffer, thereby enabling data writing to store the data in the controller memory buffer.

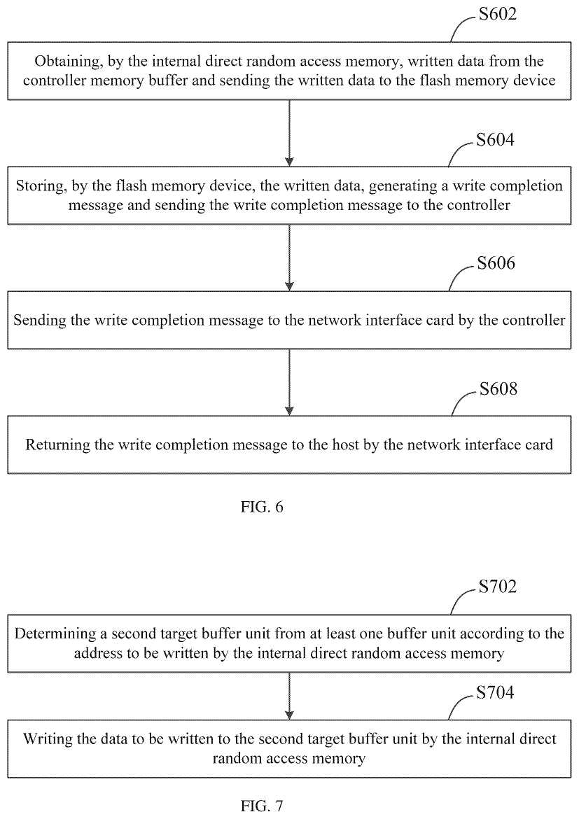

In one embodiment, as shown in FIG. 6, the aforementioned method further includes the following steps.

Step 602, obtaining, by the internal direct random access memory, written data from the controller memory buffer and sending the written data to the flash memory device.

Step 604, storing, by the flash memory device, the written data and generating a write completion message and sending the write completion message to the controller. Step 606, sending the write completion message to the network interface card by the controller.

Step 608, returning the write completion message to the host by the network interface card.

Once the data are successfully written to the controller memory buffer, it is necessary to return a message to inform the host that the data has been successfully written to the controller memory buffer of the solid-state drive. Since the controller memory buffer is a memory for temporary storage, the controller in the solid-state drive can read data from the controller memory buffer and write the data to the flash memory device.

Specifically, the internal direct random access memory reads the written data from the controller memory buffer and sends the written data to the flash memory device for storage. After receiving the written data, the flash memory device stores the written data and generates a corresponding write completion message.

Further, the flash memory device sends the generated write completion message to the network interface card through the controller. After receiving the write completion message, the network interface card returns the write completion message to the host to inform the host that the data writing has been completed.

In this way, the controller memory buffer of the solid-state drive can be used as a read/write data buffer for the storage server. This avoids the need to use the local memory and cache of the EBOF when input/output data traverses the I/O path between the storage server and the flash memory device, thereby preventing memory bandwidth reduction caused by memory congestion.

In one embodiment, as shown in FIG. 7, the controller memory buffer includes at least one buffer unit, and the writing the data to be written to the address to be written corresponding to the controller memory buffer by the internal direct random access memory includes the following steps.

Step 702, determining a second target buffer unit from the at least one buffer unit according to the address to be written by the internal direct random access memory. Step 704, writing the data to be written to the second target buffer unit by the internal direct random access memory.

When the controller memory buffer CMB includes at least one buffer unit, after the internal direct random access memory has received the address to be written, the internal direct random access memory determines a matching second target buffer unit from the at least one buffer unit according to the address to be written, and writes the data to be written to the second target buffer unit. Each buffer unit in the controller memory buffer is associated with an address, and the corresponding second target buffer unit can be determined by the address to be written.

In one embodiment, the controller includes a first register and a second register, the first register and the second register being respectively configured to describe different attribute information of the controller memory buffer.

In one embodiment, the first register defines a location of the controller memory buffer, and first attribute information corresponding to the first register is set to indicate that the controller supports the controller memory buffer.

In one embodiment, the second register defines a size of the controller memory buffer, and second attribute information corresponding to the second register is set to indicate that the controller supports the controller memory buffer.

Two registers, i.e. the first register and the second register, exist in the controller of the solid-state drive to describe different basic information of the controller memory buffer. The first register may be the Controller Memory Buffer Location (CMBLOC, which refers to the location information of the storage area), and the second register may be the Controller Memory Buffer Size (CMBSZ, which refers to the size information of the storage area).

The first register defines a location of the controller memory buffer, and when the controller does not support the controller memory buffer (CAP.CMBS), this attribute is reserved. When the controller supports the controller memory buffer and the CMBMSC.CRE is cleared to “0”, this attribute should be cleared to 0 h. In the present application, the first attribute information corresponding to the first register is set to indicate that the controller supports the controller memory buffer in order to operate on the controller memory buffer.

The second register defines a size of the controller memory buffer, and this attribute should be cleared to 0 h when the function of controller memory buffering is not supported or when the controller supports the controller memory buffer (CAP.CMBS) and the CMBMSC.CRE is cleared to “0”. In the present application, the second attribute information corresponding to the second register is set to indicate that the controller supports the controller memory buffer in order to operate on the controller memory buffer.

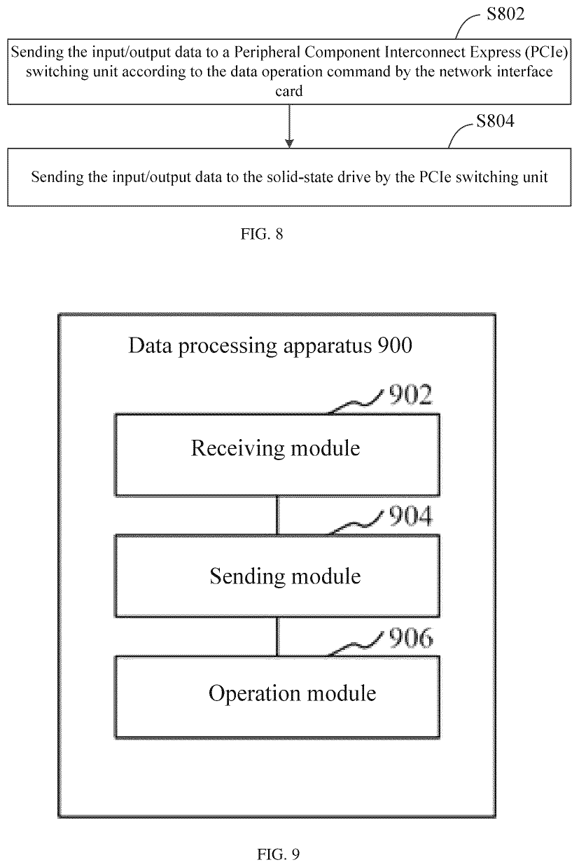

In one embodiment, as shown in FIG. 8, the sending the input/output data to the solid-state drive according to the data operation command by the network interface card includes the following steps.

Step 802, sending the input/output data to a Peripheral Component Interconnect Express (PCIe) switching unit according to the data operation command by the network interface card.

Step 804, sending the input/output data to the solid-state drive by the PCIe switching unit.

Specifically, the host sends the input/output data through its network interface card directly to the network interface card of the storage server, and completes the data transmission operation with the solid-state drive directly through the PCIe switching unit of the storage server. Further, the PCIe switching unit sends the input/output data to the solid-state drive. That is, the data transmission between the network interface card and the solid-state drive in the storage server needs to be completed through the PCIe switching unit, eliminating the need for the CPU to perform data transmission operations or memory copy operations, thereby significantly saving the CPU resources.

It should be understood that although the steps in the flowcharts described above are shown sequentially as indicated by the arrows, the steps are not necessarily performed sequentially in the order indicated by the arrows. Unless explicitly stated herein, the order, in which these steps are performed, is not strictly limited, and the steps may be performed in any other order. Moreover, at least some of the steps in the flowcharts described above may include a plurality of sub-steps or stages, which are not necessarily performed at the same time but may be performed at different times, and these sub-steps or stages are not necessarily performed in a sequential order but may be performed alternately or be interleaved with other steps or at least some of the sub-steps or stages of other steps.

In one embodiment, as shown in FIG. 9, there is provided a data processing apparatus 900, which is applied to a storage server. The storage server includes a network interface card and a solid-state drive. The solid-state drive includes a controller memory buffer. The data processing apparatus includes: a receiving module 902, a sending module 904, and an operation module 906.

The receiving module 902 is configured to receive, by the network interface card, a data operation command which is sent by a host, the data operation command carrying input/output data.

The sending module 904 is configured to send the input/output data to the solid-state drive according to the data operation command by the network interface card.

The operation module 906 is configured to operate on the controller memory buffer according to the input/output data by the solid-state drive.

In one embodiment, the solid-state drive further includes a controller, a flash memory device, and an internal direct random access memory, the internal direct random access memory including the controller memory buffer.

In one embodiment, when the data operation command is a data read command, the input/output data includes address information. The operation module 906 receives, by the controller, the address information, sends the address information to the internal direct random access memory, determines a target address corresponding to the controller memory buffer according to the address information by the internal direct random access memory, and reads target data from the target address corresponding to the controller memory buffer by the internal direct random access memory.

In one embodiment, the operation module 906 sends the target data to the controller by the internal direct random access memory, sends the target data to the network interface card as a read completion message by the controller, and returns the read completion message to the host by the network interface card.

In one embodiment, the controller memory buffer includes at least one buffer unit, and the operation module 906 determines a first target buffer unit from the at least one buffer unit according to the target address by the internal direct random access memory, and reads the target data from the first target buffer unit by the internal direct random access memory.

In one embodiment, when the data operation command is a data write command, the input/output data includes data to be written and corresponding write address information. The operation module 906 receives, by the controller, the data to be written and the corresponding write address information, sends the data to be written and the corresponding write address information to the internal direct random access memory, determines an address to be written corresponding to the controller memory buffer according to the write address information by the internal direct random access memory, and writes the data to be written into the address to be written corresponding to the controller memory buffer by the internal direct random access memory.

In one embodiment, the operation module 906 obtains written data from the controller memory buffer by the internal direct random access memory, sends the written data to the flash memory device, stores the written data by the flash memory device, generates a write completion message, sends the write completion message to the controller, sends the write completion message to the network interface card by the controller, and returns the write completion message to the host by the network interface card.

In one embodiment, the controller memory buffer includes at least one buffer unit. The operation module 906 determines a second target buffer unit from the at least one buffer unit according to the address to be written by the internal direct random access memory, and writes the data to be written into the second target buffer unit by the internal direct random access memory.

In one embodiment, the controller includes a first register and a second register, the first register and the second register being respectively configured to describe different attribute information of the controller memory buffer.

In one embodiment, the first register defines a location of the controller memory buffer, and first attribute information corresponding to the first register is set to indicate that the controller supports the controller memory buffer.

In one embodiment, the second register defines a size of the controller memory buffer, and second attribute information corresponding to the second register is set to indicate that the controller supports the controller memory buffer.

In one embodiment, the sending module 904 sends the input/output data to a Peripheral Component Interconnect Express (PCIe) switching unit according to the data operation command by the network interface card, and sends the input/output data to the solid-state drive by the PCIe switching unit. For specific definition of the data processing apparatus, please refer to the definition of the data processing method described above, and the description thereof will not be repeated here. Each module in the data processing apparatus described above may be implemented in whole or in part by software, hardware or any combination thereof. The modules described above may be embedded into or independent of a processor of a computer device in the form of hardware, or may be stored in a memory of the computer device in the form of software, so as to enable the processor to call and execute the corresponding operations of the above modules.

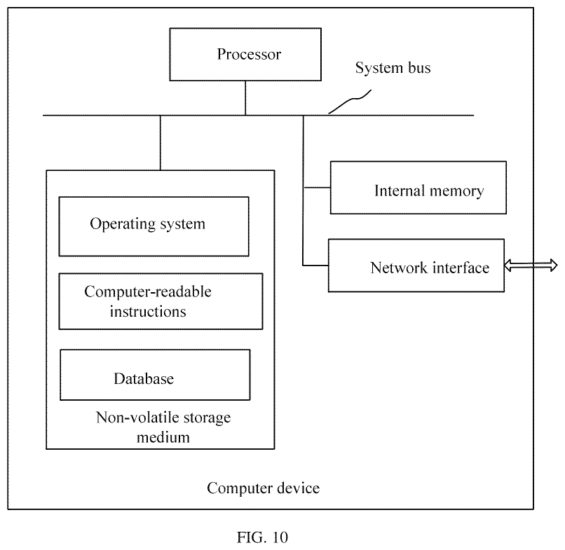

In one embodiment, a computer device is provided, which may be a server. A diagram illustrating the internal structure of the server may be as shown in FIG. 10. The computer device includes a processor, a memory, a network interface, and a database, which are connected through a system bus. Here, the processor of the computer device is used to provide computing and control capabilities. The memory of the computer device includes a non-volatile storage medium and an internal memory. The non-volatile storage medium stores an operating system, computer-readable instructions, and a database. The internal memory provides an environment for execution of the operating system and the computer-readable instructions in the non-volatile storage medium. The database of the computer device is used to store the input/output data. The network interface of the computer device is used for communication with an external terminal through a network connection. The computer-readable instructions, when executed by the processor, implement a data processing method.

Those skilled in the art can understand that the structure shown in FIG. 10 is only a block diagram of a part of a structure related to the solution of the present application and is not intended to limit the computer device, on which the solution of the present application can be applied. Specifically, the computer device may include more or fewer components than those shown in the figure, have some components combined or have a different arrangement of the components.

In one embodiment, a computer device is provided, which includes a memory, a processor, and computer-readable instructions stored on the memory and executable by the processor. The computer-readable instructions, when executed by the processor, implement the following steps: receiving, by a network interface card, a data operation command which is sent by a host, the data operation command carrying input/output data; sending the input/output data to a solid-state drive according to the data operation command by the network interface card; and operating on a controller memory buffer according to the input/output data by the solid-state drive.

In one embodiment, the solid-state drive further includes a controller, a flash memory device, and an internal direct random access memory, the internal direct random access memory including the controller memory buffer.

In one embodiment, when the data operation command is a data read command, the input/output data includes address information, and the computer-readable instructions, when executed by the processor, further implement the following steps: receiving, by the controller, the address information and sending the address information to the internal direct random access memory; determining a target address corresponding to the controller memory buffer according to the address information by the internal direct random access memory; and reading target data from the target address corresponding to the controller memory buffer by the internal direct random access memory.

In one embodiment, the computer-readable instructions, when executed by the processor, further implement the following steps: sending the target data to the controller by the internal direct random access memory; sending the target data to the network interface card as a read completion message by the controller; and returning the read completion message to the host by the network interface card.

In one embodiment, the controller memory buffer includes at least one buffer unit, and the computer-readable instructions, when executed by the processor, further implement the following steps: determining a first target buffer unit from the at least one buffer unit according to the target address by the internal direct random access memory; and reading the target data from the first target buffer unit by the internal direct random access memory.

In one embodiment, when the data operation command is a data write command, the input/output data includes data to be written and corresponding write address information, and the computer-readable instructions, when executed by the processor, further implement the following steps: receiving, by the controller, the data to be written and the corresponding write address information and sending the data to be written and the corresponding write address information to the internal direct random access memory; determining an address to be written corresponding to the controller memory buffer according to the write address information by the internal direct random access memory; and writing the data to be written to the address to be written corresponding to the controller memory buffer by the internal direct random access memory.

In one embodiment, the computer-readable instructions, when executed by the processor, further implement the following steps: obtaining, by the internal direct random access memory, written data from the controller memory buffer and sending the written data to the flash memory device; storing, by the flash memory device, the written data, generating a write completion message and sending the write completion message to the controller; sending the write completion message to the network interface card by the controller; and returning the write completion message to the host by the network interface card.

In one embodiment, the controller memory buffer includes at least one buffer unit, and the computer-readable instructions, when executed by the processor, further implement the following steps: determining a second target buffer unit from the at least one buffer unit according to the address to be written by the internal direct random access memory; and writing the data to be written to the second target buffer unit by the internal direct random access memory.

In one embodiment, the controller includes a first register and a second register, the first register and the second register being respectively configured to describe different attribute information of the controller memory buffer.

In one embodiment, the first register defines a location of the controller memory buffer, and first attribute information corresponding to the first register is set to indicate that the controller supports the controller memory buffer.

In one embodiment, the second register defines a size of the controller memory buffer, and second attribute information corresponding to the second register is set to indicate that the controller supports the controller memory buffer.

In one embodiment, the computer-readable instructions, when executed by the processor, further implement the following steps: sending the input/output data to a Peripheral Component Interconnect Express (PCIe) switching unit according to the data operation command by the network interface card; and sending the input/output data to the solid-state drive by the PCIe switching unit.

In one embodiment, there are provided one or more non-volatile computer-readable storage media having computer-readable instructions stored therein, and the computer-readable instructions, when executed by one or more processors, implement the following steps: receiving, by a network interface card, a data operation command which is sent by a host, the data operation command carrying input/output data; sending the input/output data to a solid-state drive according to the data operation command by the network interface card; and operating on a controller memory buffer according to the input/output data by the solid-state drive.

In one embodiment, the solid-state drive further includes a controller, a flash memory device, and an internal direct random access memory, the internal direct random access memory including the controller memory buffer.

In one embodiment, when the data operation command is a data read command, the input/output data includes address information, and the computer-readable instructions, when executed by the processor, further implement the following steps: receiving, by the controller, the address information and sending the address information to the internal direct random access memory; determining a target address corresponding to the controller memory buffer according to the address information by the internal direct random access memory; and reading target data from the target address corresponding to the controller memory buffer by the internal direct random access memory.

In one embodiment, the computer-readable instructions, when executed by the processor, further implement the following steps: sending the target data to the controller by the internal direct random access memory; sending the target data to the network interface card as a read completion message by the controller; and returning the read completion message to the host by the network interface card.

In one embodiment, the controller memory buffer includes at least one buffer unit, and the computer-readable instructions, when executed by the processor, further implement the following steps: determining a first target buffer unit from the at least one buffer unit according to the target address by the internal direct random access memory; and reading the target data from the first target buffer unit by the internal direct random access memory.

In one embodiment, when the data operation command is a data write command, the input/output data includes data to be written and corresponding write address information, and the computer-readable instructions, when executed by the processor, further implement the following steps: receiving, by the controller, the data to be written and the corresponding write address information and sending the data to be written and the corresponding write address information to the internal direct random access memory; determining an address to be written corresponding to the controller memory buffer according to the write address information by the internal direct random access memory; and writing the data to be written to the address to be written corresponding to the controller memory buffer by the internal direct random access memory.

In one embodiment, the computer-readable instructions, when executed by the processor, further implement the following steps: obtaining, by the internal direct random access memory, written data from the controller memory buffer and sending the written data to the flash memory device; storing, by the flash memory device, the written data, generating a write completion message and sending the write completion message to the controller; sending the write completion message to the network interface card by the controller; and returning the write completion message to the host by the network interface card.

In one embodiment, the controller memory buffer includes at least one buffer unit, and the computer-readable instructions, when executed by the processor, further implement the following steps: determining a second target buffer unit from the at least one buffer unit according to the address to be written by the internal direct random access memory; and writing the data to be written to the second target buffer unit by the internal direct random access memory.

In one embodiment, the controller includes a first register and a second register, the first register and the second register being respectively configured to describe different attribute information of the controller memory buffer.

In one embodiment, the first register defines a location of the controller memory buffer, and first attribute information corresponding to the first register is set to indicate that the controller supports the controller memory buffer.

In one embodiment, the second register defines a size of the controller memory buffer, and second attribute information corresponding to the second register is set to indicate that the controller supports the controller memory buffer.

In one embodiment, the computer-readable instructions, when executed by the processor, further implement the following steps: sending the input/output data to a

Peripheral Component Interconnect Express (PCIe) switching unit according to the data operation command by the network interface card; and sending the input/output data to the solid-state drive by the PCIe switching unit.

Those skilled in the art will appreciate that the processes of the methods in the embodiments described above can be entirely or partially accomplished by instructing related hardware through computer-readable instructions, which may be stored in a non-volatile computer-readable storage medium and, when executed, can include the processes in the embodiments of the methods described above. Here, as used in the embodiments provided by the present application, any reference to a memory, storage, a database or any other medium may include a non-volatile and/or volatile memory. The non-volatile memory may include a read-only memory (ROM), a programmable ROM (PROM), an electrically programmable ROM (EPROM), an electrically erasable programmable ROM (EEPROM) or a flash memory. The volatile memory may include a random access memory (RAM) or an external cache. By way of illustration instead of limitation, RAM is available in various forms, such as static RAM (SRAM), dynamic RAM (DRAM), synchronous DRAM (SDRAM), double data rate SDRAM (DDR SDRAM), enhanced SDRAM (ESDRAM), synchlink DRAM (SLDRAM), Rambus direct RAM (RDRAM), direct Rambus dynamic RAM (DRDRAM), and Rambus dynamic RAM (RDRAM).

The technical features in the above embodiments can be arbitrarily combined. For brevity of description, not all possible combinations of the technical features in the above embodiments are described. However, any combination of these technical features without contradiction shall be considered to fall within the scope of the present specification.

The above embodiments only express several implementations of the present application with relatively specific and detailed descriptions, but shall not be construed as limiting the scope of the patent. It should be noted that those skilled in the art can make a number of modifications and improvements without departing from the concept of the present application, and those modifications and improvements shall all fall within the scope claimed by the present application. Therefore, the scope claimed by the present patent application shall be defined by the appended claims.

1. A data processing method, being applied to a storage server, the storage server comprising a network interface card and a solid-state drive, and the solid-state drive comprising a controller memory buffer, a controller, a flash memory device, and an internal direct random access memory, the internal direct random access memory comprising the controller memory buffer, the method comprising:
receiving, by the network interface card, a data operation command which is sent by a host, the data operation command carrying input/output data;
sending the input/output data to the solid-state drive according to the data operation command by the network interface card; and
operating on the controller memory buffer according to the input/output data by the solid-state drive; wherein, when the data operation command is a data read command, the input/output data includes address information, and the operating on the controller memory buffer according to the input/output data by the solid-state drive comprises:
receiving, by the controller, the address information and sending the address information to the internal direct random access memory;
determining a target address corresponding to the controller memory buffer according to the address information by the internal direct random access memory; and
reading target data from the target address corresponding to the controller memory buffer by the internal direct random access memory.

2-3. (canceled)

4. The method according to claim 1, further comprising:
sending the target data to the controller by the internal direct random access memory;
sending the target data to the network interface card as a read completion message by the controller; and
returning the read completion message to the host by the network interface card.

5. The method according to claim 1, wherein the controller memory buffer comprises at least one buffer unit, and the reading target data from the target address corresponding to the controller memory buffer by the internal direct random access memory comprises:
determining a first target buffer unit from the at least one buffer unit according to the target address by the internal direct random access memory; and
reading the target data from the first target buffer unit by the internal direct random access memory.

6. The method according to claim 1, wherein when the data operation command is a data write command, the input/output data includes data to be written and corresponding write address information, and the operating on the controller memory buffer according to the input/output data by the solid-state drive comprises:
receiving, by the controller, the data to be written and the corresponding write address information and sending the data to be written and the corresponding write address information to the internal direct random access memory;
determining an address to be written corresponding to the controller memory buffer according to the corresponding write address information by the internal direct random access memory; and
writing the data to be written into the address to be written corresponding to the controller memory buffer by the internal direct random access memory.

7. The method according to claim 6, further comprising:
obtaining, by the internal direct random access memory, written data from the controller memory buffer and sending the written data to the flash memory device;
storing, by the flash memory device, the written data, generating a write completion message and sending the write completion message to the controller;
sending the write completion message to the network interface card by the controller; and
returning the write completion message to the host by the network interface card.

8. The method according to claim 6, wherein the controller memory buffer comprises at least one buffer unit, and the writing the data to be written into the address to be written corresponding to the controller memory buffer by the internal direct random access memory comprises:
determining a second target buffer unit from the at least one buffer unit according to the address to be written by the internal direct random access memory; and
writing the data to be written to the second target buffer unit by the internal direct random access memory.

9. The method according to claim 1, wherein the controller comprises a first register and a second register, the first register and the second register being respectively configured to describe different attribute information of the controller memory buffer.

10. The method according to claim 9, wherein the first register defines a location of the controller memory buffer, and first attribute information corresponding to the first register is set to indicate that the controller supports the controller memory buffer.

11. The method according to claim 9, wherein the second register defines a size of the controller memory buffer, and second attribute information corresponding to the second register is set to indicate that the controller supports the controller memory buffer.

12. The method according to claim 1, wherein the sending the input/output data to the solid-state drive according to the data operation command by the network interface card comprises:
sending the input/output data to a Peripheral Component Interconnect Express (PCIe) switching unit according to the data operation command by the network interface card; and
sending the input/output data to the solid-state drive by the PCIe switching unit.

13. The method according to claim 1, wherein the operating on the controller memory buffer according to the input/output data by the solid-state drive comprises:
in response to the input/output data being data carried by the data read command, reading data from the controller memory buffer according to the input/output data by the solid-state drive.

14. The method according to claim 1, wherein the operating on the controller memory buffer according to the input/output data by the solid-state drive comprises:
in response to the input/output data being data carried by a data write command, writing data into the controller memory buffer according to the input/output data by the solid-state drive.

15. The method according to claim 1, wherein the address information comprises address block information and internal address information.

16. The method according to claim 6, wherein the corresponding write address information comprises an address block to be written related to the address to be written.

17. The method according to claim 9, wherein at least one of the first register is Controller Memory Buffer Location (CMBLOC) or the second register is Controller Memory Buffer Size (CMBSZ).

18. (canceled)

19. A server comprising a memory, a processor, and computer programs stored on the memory and executable by the processor, wherein the computer programs, when executed by the processor,-implement a data processing method, being applied to a storage server, the storage server comprising a network interface card and a solid-state drive, and the solid-state drive comprising a controller memory buffer, a controller, a flash memory device, and an internal direct random access memory, the internal direct random access memory comprising the controller memory buffer, the method comprising:
receiving, by the network interface card, a data operation command which is sent by a host, the data operation command carrying input/output data;
sending the input/output data to the solid-state drive according to the data operation command by the network interface card; and
operating on the controller memory buffer according to the input/output data by the solid-state drive; wherein, when the data operation command is a data read command, the input/output data includes address information, and the operating on the controller memory buffer according to the input/output data by the solid-state drive comprises:
receiving, by the controller, the address information and sending the address information to the internal direct random access memory;
determining a target address corresponding to the controller memory buffer according to the address information by the internal direct random access memory; and
reading target data from the target address corresponding to the controller memory buffer by the internal direct random access memory.

20. A computer-readable storage media having computer programs stored therein, wherein the computer programs, when executed by one or more processors, cause the one or more processors to perform a data processing method, being applied to a storage server, the storage server comprising a network interface card and a solid-state drive, and the solid-state drive comprising a controller memory buffer, a controller, a flash memory device, and an internal direct random access memory, the internal direct random access memory comprising the controller memory buffer, the method comprising:
receiving, by the network interface card, a data operation command which is sent by a host, the data operation command carrying input/output data;
sending the input/output data to the solid-state drive according to the data operation command by the network interface card; and
operating on the controller memory buffer according to the input/output data by the solid-state drive; wherein, when the data operation command is a data read command, the input/output data includes address information, and the operating on the controller memory buffer according to the input/output data by the solid-state drive comprises:
receiving, by the controller, the address information and sending the address information to the internal direct random access memory;
determining a target address corresponding to the controller memory buffer according to the address information by the internal direct random access memory; and
reading target data from the target address corresponding to the controller memory buffer by the internal direct random access memory.

21. The server according to claim 19, wherein the computer programs, when executed by the processor, are further configured to cause the processor to:
send the target data to the controller by the internal direct random access memory;
send the target data to the network interface card as a read completion message by the controller; and
return the read completion message to the host by the network interface card.

22. The server according to claim 19, wherein the controller memory buffer comprises at least one buffer unit, and the computer programs, when executed by the processor, are further configured to cause the processor to:
determine a first target buffer unit from the at least one buffer unit according to the target address by the internal direct random access memory; and
read the target data from the first target buffer unit by the internal direct random access memory.

23. The server according to claim 19, wherein the input/output data includes data to be written and corresponding write address information, and the computer programs, when executed by the processor, are further configured to cause the processor to:
receive, by the controller, the data to be written and the corresponding write address information and sending the data to be written and the corresponding write address information to the internal direct random access memory;
determine an address to be written corresponding to the controller memory buffer according to the corresponding write address information by the internal direct random access memory; and
write the data to be written into the address to be written corresponding to the controller memory buffer by the internal direct random access memory.
